(19) United States
(12) Patent Application Publication
(10) Pub. No.: US 2026/0283213 A1
(43) Pub. Date: Sep. 24, 2026

(54) SYSTEMS AND METHODS FOR AGRICULTURAL PRODUCT RECEIVING, CLEANING, AND WEIGHING

(71) Applicant: Amalgamated Sugar Company, Boise, ID (US)

(72) Inventor: Roy Withers, Burley, ID (US)

(73) Assignee: Amalgamated Sugar, Boise, ID (US)

(21) Appl. No.: 19/083,923

(22) Filed: Mar. 19, 2025

(51) Int. Cl. A23N 12/00

(52) U.S. Cl. CPC A23N 12/005

(57) ABSTRACT

Systems and methods for an agricultural product cleaner and piler machine having a hopper for receiving agricultural product, an incline section to transport the agricultural product from the hopper to a cleaning section, the cleaning section including one or more grab rollers, one or more reversing rollers, and wherein the one or more grab rollers and one or more reversing rollers are configured to roll or rotate the agricultural product to remove debris from the agricultural product, and a clean product conveyor to receive the agricultural product from the cleaning section.

### FIELD OF THE DISCLOSURE

This disclosure relates generally to agricultural equipment, such as a sugar beet cleaner and piler. More particularly this disclosure relates to systems and methods for receiving, cleaning, weighing, and piling agricultural products.

### BACKGROUND

Current systems and methods for receiving, cleaning, piling, and weighing agricultural products, such as sugar beets, have several issues, inconveniences, inefficiencies, problems, and drawbacks. For example, the quality of the final product can be affected by residual soil and debris affecting the cleanliness of the product, such as sugar beets. Current methods and machines may also be quite abusive to the product, which affects the long term storage viability.

Likewise, variability in moisture content and left-on debris can lead to inaccurate weight measurements, poor product storability, and processing efficiency. Further, residual debris necessitates frequent cleaning and calibration of equipment to ensure accuracy and prevent breakdowns.

In general, current cleaning and weighing processes can be time-consuming, limit throughput capacity, increase damage to product and lead to delays in production and other inefficiencies. Other issues, inconveniences, drawbacks, inefficiencies, and problems with current systems and methods also exist.

### SUMMARY

Accordingly, disclosed embodiments address the above, and other, issues, inconveniences, drawbacks, inefficiencies, and problems with current systems and methods.

Disclosed embodiments include an agricultural product cleaner and piler machine having a hopper for receiving agricultural product, an incline section to transport the agricultural product from the hopper to a cleaning section, the cleaning section including one or more grab rollers and one or more reversing rollers, and wherein the one or more grab rollers and one or more reversing rollers are configured to roll or rotate the agricultural product to remove debris from the agricultural product. Disclosed embodiments also include a clean product conveyor to receive the agricultural product from the cleaning section.

Disclosed embodiments also include a pivot to enable the incline section to enable the incline section and the cleaning section to articulate with respect to one another.

In some disclosed embodiments the one or more grab rollers and the one or more reversing rollers are configured to rotate in at least two directions.

In some disclosed embodiments the one or more grab rollers and the one or more reversing rollers are configured to rotate independently of each other.

In some disclosed embodiments the one or more grab rollers and the one or more reversing rollers are configured to rotate in opposite directions.

In some disclosed embodiments the one or more grab rollers and the one or more reversing rollers are configured to rotate at adjustable speeds.

In some disclosed embodiments the one or more grab rollers and the one or more reversing rollers are configured to rotate at adjustable speeds independently of each other.

In some disclosed embodiments the one or more grab rollers and the one or more reversing rollers are configured to rotate at different speeds with respect to one another.

Disclosed embodiments also include a belt located in the incline section to enable the incline section to transport the agricultural product from the hopper to the cleaning section. In some disclosed embodiments the belt is driven by force applied to an interior surface of the belt. In some disclosed embodiments the belt includes protrusions on the interiors surface that engage reciprocal portions on a driving sprocket.

Also disclosed are methods for cleaning and piling agricultural product including depositing agricultural product into a hopper, transporting the agricultural product along an incline from the hopper to a cleaning section, cleaning the agricultural product in the cleaning section by rotating the agricultural product with one or more grab rollers and one or more reversing rollers, and conveying the agricultural product from the cleaning section.

In some disclosed embodiments the method may include pivoting the incline section and the cleaning section with respect to one another.

Other embodiments also exist.

### BRIEF DESCRIPTION OF THE DRAWINGS

FIG. 1 is a side view of a machine in accordance with disclosed embodiments.

FIG. 2 is a side view of a section of the machine of FIG. 1 in an articulated position in accordance with disclosed embodiments.

FIG. 3 is a close up, interior view of a portion of the machine of FIG. 2 between incline and cleaning sections in accordance with disclosed embodiments.

FIG. 4A is a partial, isometric side view of a belt driving sprocket and belt in accordance with disclosed embodiments.

FIG. 4B is a partial side view of the belt and belt driving sprocket of FIG. 4A.

FIG. 5 is a partial, isometric top view of cleaning section in accordance with disclosed embodiments.

FIGS. 6A-6B are partial, side view of cleaning section showing the gang hanger plate in different positions in accordance with disclosed embodiments.

FIG. 7 is a partial, isometric, top view of a portion of machine 100 in accordance with disclosed embodiments.

FIG. 8 is a close-up view of a portion of the clean product conveyor 164 shown in dashed box 8 of FIG. 7 in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

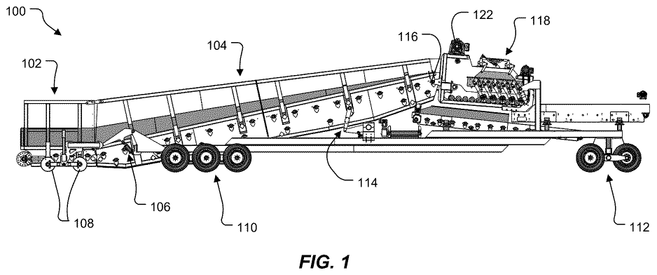

FIG. 1 is a side view of a machine 100 in accordance with disclosed embodiments. Embodiments of machine 100 include a hopper section 102 where agricultural products, such as sugar beets and the like, may be deposited from a truck or other loader. Hopper section 102 may include a variety of beds, driven belts, hoists, or the like to facilitate loading and transport of agricultural products. Hopper 102 may also include hopper hydraulics 106 to, among other things, enable the lifting of hopper 102 to facilitate towing and to enable along with bull wheels 108 “floating” of the hopper 102 as it follows contours of the ground or field.

Embodiments of machine 100 also include incline section 104. In some embodiments, incline section 104 may be of a wider than typical width, such as 96 inches (i.e., 8 feet or 2.44 meters), to, among other things, match the width of cleaning section 118 as described herein and provide for smooth gentle transitions for the product as it passes through the machine 100.

Embodiments of machine 100 also may include a rear wheel and axle set 110 and front wheel and axle set 112, which may also be connected to a hitch (not shown), to enable, among other things, towing of the machine 100 to other locations or to storage or to a shop for maintenance and the like. In some embodiments one or both of wheel and axle sets 110, 112 may also comprise belts, tracks, or other ground contacting mechanisms.

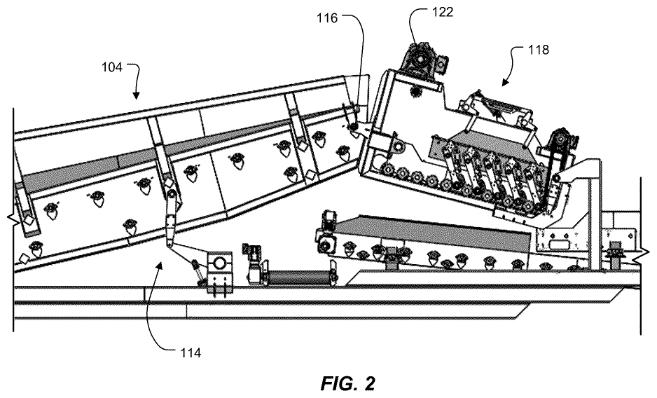

Embodiments of machine 100 also include incline hydraulics and rockshaft 114 and pivot 116 that enable incline section 104 and cleaning section 118 to articulate with respect to one another as shown in the relative positions of FIG. 1 compared to FIG. 2. Articulation of cleaning section 118 allows the pitch of cleaning section 118 to change as desired as disclosed herein. The pitch of cleaning section 118, among other things, changes the dwell time of agricultural product in the cleaning section 118. Typically, the smaller the pitch (e.g., 0°-5°) will result in a longer dwell time of the agricultural product in the cleaning section 118 and a higher pitch (e.g., 15°-22°) will result in a shorter dwell time. Longer dwell times may be desirable, for example, when the agricultural product has a significant amount of dirt or mud that needs to be removed.

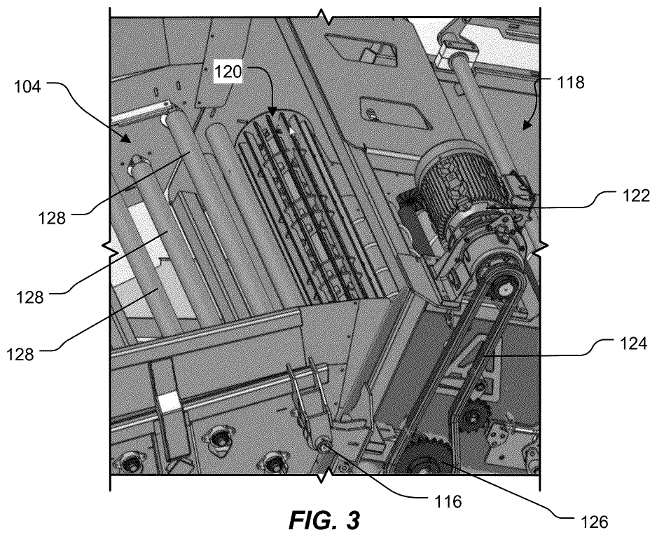

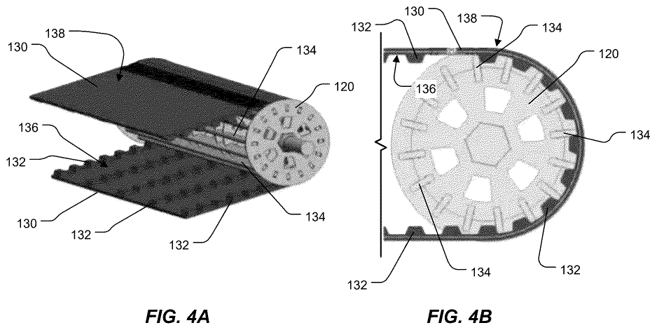

FIG. 3 is a close up, interior view of a portion of machine 100 between incline 104 and cleaning 118 sections in accordance with disclosed embodiments. As shown a belt driving sprocket 120 in cleaning section 118 which may be driven by an electric motor 122, or the like, to drive a belt or chain 124 over a sprocket 126 connected to a shaft of driving sprocket 120. Embodiments of belt driving sprocket 120 provide a positive drive force for a belt 130 (removed in FIG. 3 to view other components, visible in FIGS. 4A-4B) that moves agricultural product up incline 104 and into cleaning section 118. As also shown, a number of rollers 128 may support the belt 130 and agricultural product as they move through incline section 104.

FIG. 4A is a partial, isometric side view of a belt driving sprocket 120 and belt 130 in accordance with disclosed embodiments and FIG. 4B is a partial side view of the same. As shown embodiments of belt 130 may have a number of lugs, protrusions, cams, cleats, or the like 132 on an interior surface 136 of belt 130 that engage with corresponding (or reciprocal) teeth, bars, cams, lugs, or the like 134 on belt driving sprocket 120. Among other things, this configuration enables belt 130 to be positively driven by forces on the interior surface 136 of the belt which can reduce belt tension, belt wear, allows for the relative movement between incline section 104 and cleaning section 118 without effecting belt tension, and reduces the need for costly and complex dynamic belt tensioning. In some embodiments, belt 130 may have a smooth surface and may engage with scrapers or the like positioned in incline 140 to remove dirt and the like from outer surface 138 at preselected locations.

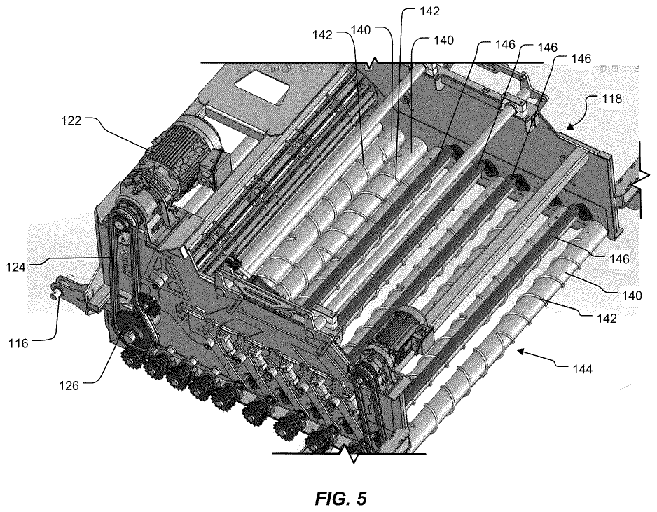

FIG. 5 is a partial, isometric top view of cleaning section 118 in accordance with disclosed embodiments. As shown embodiments of cleaning section 118 may have a number of grab rollers 140 having spiral or helical protrusions 142 that, when rotated, urge agricultural product in a chosen direction (e.g., to a left or right side of cleaning section 118). In the embodiment shown in FIG. 5, helical protrusions 142 change direction of helix substantially at the middle 144 of grab roller 140 (and cleaning section 118), thus, urging agricultural product towards the middle of cleaning section 118 when rotating. The grab rollers 140 and the helical protrusions 142 on them provide push and pull effect as the product is passing through the cleaning section 118. The embodiment shown in FIG. 5 has machine 100 configured so the grab rollers 140 are alternating in effect, however, other configurations can also be implemented (e.g., oriented all in the same direction, alternating every second roller 140, every third roller 140, etc., and the like). Additionally, grab rollers 140 also roll or rotate product as it pushes/pulls product passing through cleaning section 118, enabling cleaning on multiple surfaces of the product.

In some embodiments reversing rollers 146 may be configured to rotate in either direction (i.e., clockwise or counterclockwise) to, among other things, accelerate or decelerate the movement of agricultural product through cleaning section 118. For example, if grab rollers 140 are rotating clockwise and reversing rollers 146 are rotating counterclockwise it will tend to decelerate the flow of agricultural product through cleaning section 118. Conversely, if grab rollers 140 and reversing rollers 146 are both rotating clockwise it will tend to accelerate the flow of agricultural product through cleaning section 118. The combined action of grab rollers 140 and reversing rollers 146 may be used to facilitate the removal of dirt or leaf debris from the agricultural product. Embodiments of machine 100 also include the ability to configure cleaning section 118 to clean product in different ways. For example, embodiments may be enabled to independently vary the speed of the grab rollers 140 and reversing rollers 146. These speed variations coupled with the ability to modify the position of the reversing rollers 146 relative to the grab rollers 140 enable cleaning section 118 to clean product in a customizable manner.

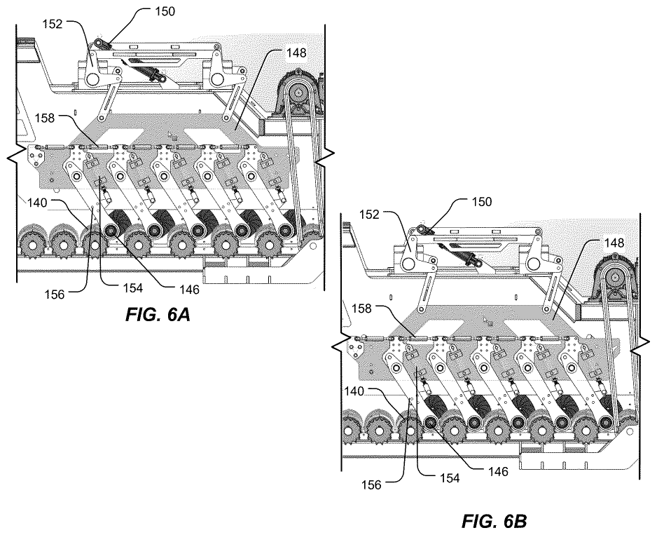

FIGS. 6A-6B are partial, side view of cleaning section 118 showing gang hanger plate 148 in different positions in accordance with disclosed embodiments. By operation (i.e., extension and retraction) of top piston 150, rock shaft 152, gang hanger plate 148, and bottom linkage 156 will move reversing rollers 146 tangentially up and down (i.e., vertically) with respect to the grab rollers 140. This also allows control over the amount of pinching, damming, and/or retarding of the agricultural product as it moves through the cleaning section 118. For example, for the higher position of reversing rollers 146 with respect to the grab rollers 140 as shown in FIG. 6A will result in a greater retarding of flow of agricultural product through the cleaning section 118. Conversely, the lower position of reversing rollers 146 with respect to the grab rollers 140 as shown in FIG. 6B will result in a lesser retarding of flow of agricultural product through the cleaning section 118.

As also illustrated in FIGS. 6A-6B embodiments may include safety or anti-jamming mechanisms such as lower pistons 154 to enable the release (i.e., motion of the reversing roller 146 away from the grab roller 140) of reversing roller 146 when desirable, such as when a rock or other non-desirable object enters cleaning section 118. Embodiments of pistons 150, 154 may be pneumatic, hydraulic, combinations of the two, and the like and may include controllable pressures to operate in the manner desired. As also will be understood by those of ordinary skill in the art having the benefit of this disclosure, cleaning section 118 may include a similar or identical gang hanger 148 setup on the other side of the cleaning section 118 (not shown in FIGS. 6A-6B). Also shown are turnbuckles 158 that facilitate the discrete positioning of each individual reversing roller 146 relative to the grab rollers 140.

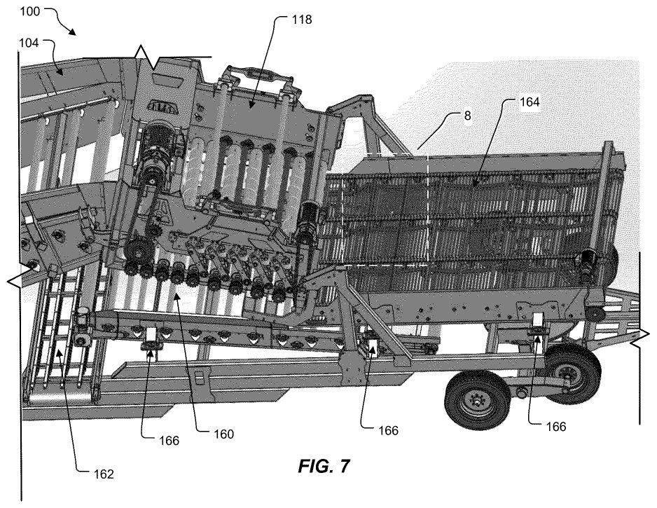

FIG. 7 is a partial, isometric, top view of a portion of machine 100 in accordance with disclosed embodiments. As illustrated, embodiments of machine 100 include a return dirt conveyor 160 (shown with belt removed for clarity in FIG. 7) positioned generally underneath cleaning section 118. Return dirt conveyor 160 catches dirt removed from the agricultural product by cleaning section 118 and may deposit the dirt onto one or more cross conveyors 162 (shown with belt removed for clarity in FIG. 7) and into trucks or other receptacles for weighing and other processing. As also shown, clean product conveyor 164 catches the cleaned agricultural product and conveys it to trucks or other receptacles for weighing and other processing. In some embodiments, return dirt conveyor 160, cross conveyor 162, and clean product conveyor 164 may be equipped with weighing mechanisms, such as load cells 166, to provide weight measurements onboard machine 100.

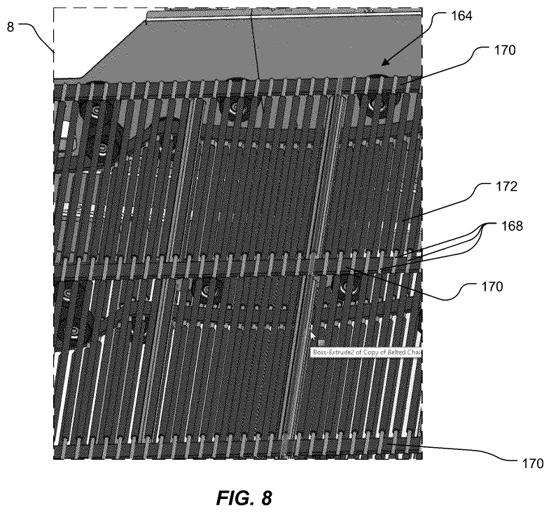

FIG. 8 is a close-up view of a portion of the clean product conveyor 164 shown in dashed box 8 of FIG. 7 in accordance with disclosed embodiments. As illustrated, embodiments of clean product conveyor may include a belted chain conveyor comprising a number of bars 168 fastened to webbing or belts 170 to form an open belt surface that enables additional dirt from the agricultural product to fall onto return dirt conveyor 160. In some embodiments bars 168 may be steel or other durable metal and may be riveted to webbing 170. In some embodiments bars 168 may include a covering 172 of rubber, foam, or the like.

Although various embodiments have been shown and described, the present disclosure is not so limited and will be understood to include all such modifications and variations would be apparent to one skilled in the art.

What is claimed is:

1. An agricultural product cleaner and piler machine comprising:
a hopper for receiving agricultural product;
an incline section to transport the agricultural product from the hopper to a cleaning section;
the cleaning section comprising:
one or more grab rollers;
one or more reversing rollers;
wherein the one or more grab rollers and one or more reversing rollers are configured to roll or rotate the agricultural product to remove debris from the agricultural product; and
a clean product conveyor to receive the agricultural product from the cleaning section.

2. The agricultural product cleaner and piler machine of claim 1 further comprising:
a pivot to enable the incline section to enable the incline section and the cleaning section to articulate with respect to one another.

3. The agricultural product cleaner and piler machine of claim 1 wherein the one or more grab rollers and the one or more reversing rollers are configured to rotate in at least two directions.

4. The agricultural product cleaner and piler machine of claim 3 wherein the one or more grab rollers and the one or more reversing rollers are configured to rotate independently of each other.

5. The agricultural product cleaner and piler machine of claim 3 wherein the one or more grab rollers and the one or more reversing rollers are configured to rotate in opposite directions.

6. The agricultural product cleaner and piler machine of claim 1 wherein the one or more grab rollers and the one or more reversing rollers are configured to rotate at adjustable speeds.

7. The agricultural product cleaner and piler machine of claim 6 wherein the one or more grab rollers and the one or more reversing rollers are configured to rotate at adjustable speeds independently of each other.

8. The agricultural product cleaner and piler machine of claim 6 wherein the one or more grab rollers and the one or more reversing rollers are configured to rotate at different speeds with respect to one another.

9. The agricultural product cleaner and piler machine of claim 1 further comprising:
a belt located in the incline section to enable the incline section to transport the agricultural product from the hopper to the cleaning section.

10. The agricultural product cleaner and piler machine of claim 9 wherein the belt is driven by force applied to an interior surface of the belt.

11. The agricultural product cleaner and piler machine of claim 10 wherein the belt comprises protrusions on the interiors surface that engage reciprocal portions on a driving sprocket.

12. A method for cleaning and piling agricultural product, the method comprising:
depositing agricultural product into a hopper;
transporting the agricultural product along an incline from the hopper to a cleaning section;
cleaning the agricultural product in the cleaning section by rotating the agricultural product with one or more grab rollers and one or more reversing rollers; and
conveying the agricultural product from the cleaning section.

13. The method for cleaning and piling agricultural product of claim 12 further comprising:
pivoting the incline section and the cleaning section with respect to one another.

14. The method for cleaning and piling agricultural product of claim 12 wherein the one or more grab rollers and the one or more reversing rollers are configured to rotate in at least two directions.

15. The method for cleaning and piling agricultural product of claim 14 wherein the one or more grab rollers and the one or more reversing rollers are configured to rotate independently of each other.

16. The method for cleaning and piling agricultural product of claim 14 wherein the one or more grab rollers and the one or more reversing rollers are configured to rotate in opposite directions.

17. The method for cleaning and piling agricultural product of claim 14 wherein the one or more grab rollers and the one or more reversing rollers are configured to rotate at adjustable speeds.

18. The method for cleaning and piling agricultural product of claim 17 wherein the one or more grab rollers and the one or more reversing rollers are configured to rotate at adjustable speeds independently of each other.

19. The method for cleaning and piling agricultural product of claim 17 wherein the one or more grab rollers and the one or more reversing rollers are configured to rotate at different speeds with respect to one another.

20. The method for cleaning and piling agricultural product of claim 12 further comprising:
transporting the agricultural product from the hopper to the cleaning section along a belt driven by force applied to an interior surface of the belt.
